(19) United States
(12) Patent Application Publication
(10) Pub. No.: US 2008/0133550 A1
(43) Pub. Date: Jun. 5, 2008

(54) Method and system for integrated asset management utilizing multi-level modeling of oil field assets

(75) Inventors: Abdollah Orangi, Irvine, CA (US); William J. Da Sie, Danville, CA (US); Viktor K. Prasanna, Pacific Palisades, CA (US); Cong Zhang, Alhambra, CA (US); Amol Bakshi, Pasadena, CA (US)

Correspondence Address: CHEVRON CORPORATION, P.O. BOX 6006, SAN RAMON, CA, 94583-0806, US

(73) Assignee: The University of Southern California

(21) Appl. No.: 11/505,163

(22) Filed: Aug. 15, 2006

Related U.S. Application Data
(60) Provisional application No. 60/708,668, filed on Aug. 15, 2005.

(51) Int. Cl. G06F 17/30; G06Q 10/00

(52) U.S. Cl. 707/100; 705/28; 707/E17.005

(57) ABSTRACT

A method for creating an integrated asset management system for an oilfield, the method including: creating a plurality of models representing asset components each model having more than one levels of detail; connecting the more than one models to communicate with one another to create an integrated asset management system; selecting the levels of detail for the more than one models; and performing an analysis on the integrated asset management system utilizing the selected levels of detail to predict a characteristic of the integrated asset management system.

This application claims the benefit under 35 USC 119 of Provisional Application No. 60/708,668, filed Aug. 15, 2005.

### I. FIELD OF INVENTION

The present invention relates to a method and system for integrated asset management of oil field assets such as subterranean reservoirs, well bores, pipe network systems, separators and fluid processing systems and non-physical assets such as optimizers, control systems and other calculators.

### II. BACKGROUND OF THE INVENTION

Integrated Asset Management (“IAM”) systems tie together or model the operations of many physical and non-physical assets or components of an oilfield. Examples of physical assets or components might include subterranean reservoirs, well bores connecting the reservoirs to pipe network systems, separators and processing systems for processing fluids produced from the subterranean reservoirs and heat and water injection systems. Non-physical assets or components can include reliability estimators, financial calculators, optimizers, uncertainty estimators, control systems, historical production data, simulation results, etc. Two examples of commercially available software programs for modeling IAM systems include AVOCET™ IAM software program, available from Schlumberger Corporation of Houston, Tex. and INTEGRATED PRODUCTION MODELING (IPM™) toolkit from Petroleum Experts Inc. of Houston, Tex.

Conventional IAM systems are generally built to be specific to particular oilfield processes. Accordingly, the systems are not readily adaptable to be used in new workflows and processes which may have many different characteristics. Some systems may wish to employ control strategies, uncertainty handling, and scenario modeling to provide better frameworks for decision support. Further expansion of these systems to new workflows that integrate heterogeneous domain analyses such as combining reliability estimates with volume forecasting requires extensive reconfiguration to these systems.

Conventional IAM systems do not allow for variation of the patterns of interaction in characterizing an integrated system. These conventional systems couple single instances or representations of one asset model to the other, for example, one pipe flow model instance to one reservoir model realization at a predefined interface point. These programs do not allow for aggregation of an assembly of asset models in a plurality-to-one relationship, or aggregation of models at differing levels of detail before aggregating and scaling to coarser levels.

Another limitation most IAM systems have is that connections between assets are generally on a single level or tier of complexity or detail. Accordingly, the complexity or detail of communication between assets can not be readily adapted to meet the needs of simpler or more complex analyses. For example, in Schlumberger's Avocet™ IAM software program, an ECLIPSE™ reservoir simulator communicates with a piping system program PIPESIM™, which in turn, communicates with facilities processing program HYSIS™. These software programs are available from Schlumberger Corporation and Aspen Technology of Cambridge, Mass., respectively. The level of detail of information passed between these assets is determined by the nature of the simulators themselves. Accordingly, the level of information exchanged between assets can not be easily scaled or lumped to work on an as needed basis.

There is a need for methods and systems for integrated asset management which overcomes the aforementioned shortcomings. The present invention addresses these needs.

### III. SUMMARY OF THE INVENTION

The invention in another embodiment includes a method for creating an integrated asset management system for an oilfield, the method including: creating a plurality of models representing asset components each model having a plurality of levels of detail; connecting the plurality of models to communicate with one another to create an integrated asset management system; selecting the levels of detail for the plurality of models; and performing an analysis on the integrated asset management system utilizing the selected levels of detail to predict a characteristic of the integrated asset management system.

The invention in another embodiment includes an integrated asset management system for an oilfield including: a plurality of models representing asset components of an oil field, at least two of the plurality of models having a plurality of levels of details; connections to allow communication between the models having the plurality of levels of details; where the level of complexities of models may be selected such that the level of analysis on the integrated asset management system can be performed at a selected level of detail.

The invention in another embodiment includes a method for unified application integration of complex software applications in the petroleum industry including: a machine-readable program storage medium tangibly embodying sequences of instructions, the sequences of instructions for execution by at least one processing system, the sequences of instructions to perform steps for: creating a plurality of models representing asset components of an oil field each having a plurality of levels of details; connecting the plurality of models to communicate with one another to create an integrated asset management system; selecting the levels of complexities for the plurality of models; and performing an analysis on the integrated asset management system utilizing the selected levels of details to predict a characteristic of the integrated asset management system.

The invention in another embodiment includes a system for developing an integrated asset management framework for an oilfield including: a metamodel having classes and subclasses representing asset components and component connectors at multiple levels of detail for modeling a plurality of oilfield-domain specific software applications and their associated input and output data signals, wherein the metamodel is adapted and configured for generating instantiated models at multiple levels of detail of a plurality of different oilfields by user selection of components and component connectors for each given oilfield; a graphical user interface configured and adapted for user selection of components and component connectors for instantiating a model for each given oilfield; a least one model interpreter configured and adapted for communication between different instantiated models; an XML schema configured and adapted for storing input and output signals of the a plurality of oilfield-domain specific software applications; and an assumption manager configured and adapted for maintaining assumptions consistently between the instantiated models and multiple levels of instantiated models.

It is an object of the present invention to create an IAM system for an oil field which has multi-levels or tiers of integration, abstraction and visualization available for the modeling of the oil field's physical assets and non-physical assets.

It is another object to create an IAM system for an oil field which uses a Generic Modeling Environment (“GME”) toolkit to create the IAM system such that it is readily extensible.

Yet another object is to provide a multi-level IAM system which includes an assumption manager and/or proxy generator which enhances the communication between different levels or tiers of asset or attribute models.

These and other features and advantages of the present invention will be made more apparent through a consideration of the following detailed description of a preferred embodiment of the invention. In the course of this description, frequent reference will be made to the attached drawings.

### IV. BRIEF DESCRIPTION OF THE DRAWINGS

FIG. 1 is a schematic flowchart of the development of an IAM system, made in accordance with one embodiment of the present invention, using a GME toolkit.

FIG. 2 is a schematic drawing in one embodiment of a modeling environment which includes a model editing window, a model browser, a part browser and an attribute panel.

FIG. 3 is a schematic drawing in one embodiment of the invention of a metamodel and corresponding instantiated model for a static aspect.

FIG. 4 shows schematic drawing in one embodiment of the invention of a metamodel and corresponding instantiated model for a dynamic aspect.

FIG. 5a is a schematic drawing of a metamodel for an example set of physical components or assets.

FIG. 5b is a schematic drawing of an instantiated model of physical components or assets based on the metamodel corresponding to FIG. 5a.

FIG. 6a is a schematic drawing of a metamodel for an example set of non-physical components or assets.

FIG. 6b is a schematic drawing of an instantiated model of non-physical components or assets based on the metamodel corresponding to FIG. 6a.

FIG. 7 is a schematic drawing illustrating how proxies are used to simplify and manage the creation of a large metamodel.

FIG. 8 is a schematic drawing in one embodiment of the invention of the use of hierarchies in a static view.

FIG. 9 is a schematic drawing in one embodiment of the invention of the use of hierarchies in a dynamic view.

FIG. 10 is a schematic drawing of a model of data exchange interfaces.

FIG. 11a is a schematic drawing in one embodiment of the invention of a well in level 1 of complexity or detail.

FIG. 11b is a schematic drawing in one embodiment of the invention of a well in level 2 of complexity or detail.

FIG. 11c is a schematic drawing in one embodiment of the invention of a well in level 3 of complexity or detail.

FIG. 12a is a schematic drawing in one embodiment of the invention of a pipe network level 1 of complexity or detail.

FIG. 12b is a schematic drawing in one embodiment of the invention of a pipe network level 2 of complexity or detail.

FIG. 12c is a schematic drawing in one embodiment of the invention of a pipe network level 3 of complexity or detail.

### V. DETAILED DESCRIPTION OF THE INVENTION

### A. Overview

The potential exists for significant improvements in the management and optimization of producing assets of an oil field if predictive integrated simulations were available to a broad audience of decision makers in addition to technical experts in each domain. The present invention accommodates this potential by providing an IAM system which has assets or attributes which are modeled, preferably graphically, at multiple levels of complexity or detail. This multi-level modeling provides higher levels of analysis and new patterns of interaction among domain expert tools like reservoir, surface network, and process simulation.

In addition to supporting high level decisions, the system provides a framework to support parallel engineering initiatives going on at various levels of detail. Engineers working low level details receive reliable information on the “boundary conditions” and “impacts” of the full-field view available during alternative analyses. The resulting integrated asset model in one embodiment preferably is combined with a decision support system, enabling users to consult the model when making decisions or analyzing past decisions.

Asset management decisions may be decided using interactions among multiple domain experts, each capable of running detailed technical analysis on highly specialized and often computer intensive applications. Alternatively, many established proxy (or reduced form engineering) models are incorporated to meet demands of rapid decision making in an operational environment or when data is limited or unavailable. A challenge arising from these previous two conditions is the ability to rapidly deliver relevant data to these applications at the desired frequency and/or density and synchronized in time over multiple sources.

Technical analysis executed in parallel domains over extended periods can result in divergence of assumptions regarding boundary conditions between domains. In a preferred embodiment, the present invention provides an assumption manager to coordinate these assumptions regarding boundary conditions between assets or non-physical attributes. An assumption at one level of complexity or detail may change. The assumption manager then checks and readjusts the assumptions at a different level of complexity to comply with the changed assumption. Also, in a preferred embodiment, a proxy generator is used to create proxies necessary to allow for communication of between the models having multiple levels of complexity or detail.

The present invention preferably uses a Generic Modeling Environment in order to create Integrated Asset Management systems. In one embodiment preferably, a number of the connections between assets of the IAM system are multi-level. That is, the number of variables and granularity of information being passed between assets can selected on an as needed basis. For example, a high level manager may wish to run the IAM system on a very high level with only one or two pieces of information being communicated between a particular pair of assets. The manager may decide that he only wants to know the quantity of oil or water passed from a set of wells to a collecting system of pipes and then to a processing system. The IAM system can be set to run at a high level without the need to run a detailed reservoir simulation in this instance. Perhaps tabulated performance curve from an assembly of assets is all that is needed to provide the information desired by the manager.

Alternatively, a reservoir engineer may want to know many characteristics of the operating reservoir such quantities of oil, water and gas production, temperature, pressure, fluid composition, etc. Accordingly, the IAM system can be appropriately set up run a detailed simulation in which all of these variables can be calculated and passed on to a piping system such as PIPESIM™. This selectivity in levels of asset simulation and levels of communication between assets which is to be used in the IAM system leads to greater efficiency in the use of the IAM system of the present invention as compared to conventional IAM systems.

IAM systems can be built, e.g., by using GME tools to create a universal model-based framework readily adaptable by a wide range of type of oilfields. The GME tools can be rapidly customized to create a domain-specific modeling environment for IAM. The domain-specific modeling environment created using GME tools provides many types of assets, both physical and non-physical, as building blocks which can be employed in a customized IAM system. A user specifies the characteristics of the oilfield and the generic framework can be customized to provide just the desired non-physical and physical assets needed to model the oilfield. Ideally, the IAM system will automatically write much of the computer code needed to connect the assets of the IAM system together, i.e., such as with a CASE (Computer Aided Software Engineering) tool.

For one or more of the assets, preferably the asset can be horizontally or vertically selected as desired by a user. For example, on a horizontal level, a choice of detailed reservoir simulators may be selected to be used in a run of the IAM systems. For example, the user may be allowed to select ECLIPSE™, CHEARS™, or any other commercially available reservoir simulator. On a vertical level, rather than running a full-scale reservoir simulation, a determination of reservoir properties may be selected at a much higher level, such as using a production curve or other proxy in place of the full-scale reservoir simulation. In all cases, model interpreters are used to pass information between the different assets, i.e., a model of a reservoir performance and an associated piping system.

A model interpreter is a piece of software code that can read the model information provided by the end user through the GME tools, and perform the desired action. For example, the desired actions could include code generation, visualization of the model information in a different format, etc. In the case of the full scale simulators, the model interpreter will be able to receive all or most of the input or output variables from any of the selection of reservoir simulators to be supported by the IAM system and pass on generic input or output variables to the piping system.

In a similar fashion, the piping systems supported by the IAM system can convert the generic input or output variables into the variables normally utilized in the piping program. In the case of PIPESIM™, exemplary input or output variables might include mass flow or temperature profiles. Also, at a high level model of a reservoir asset, the model interpreter allows communication from the output curve to the piping system. In a similar manner, many of the assets may communicate between one another at various levels and using various desired programs within an asset.

The IAM system of the present invention in a preferred embodiment also readily handles communication between assets which operate on different time scales. For example, a reservoir simulator may operate on a basis of several days, weeks or even months, while the processing unit is modeled on a time scale of minute to minute operation. This communication of assets operating on different time scales is facilitated in one preferred embodiment by applying system component interpreters within the GME environment.

### B. Multi-Level Integrated Asset Management System Created Utilizing a Generic Modeling Environment

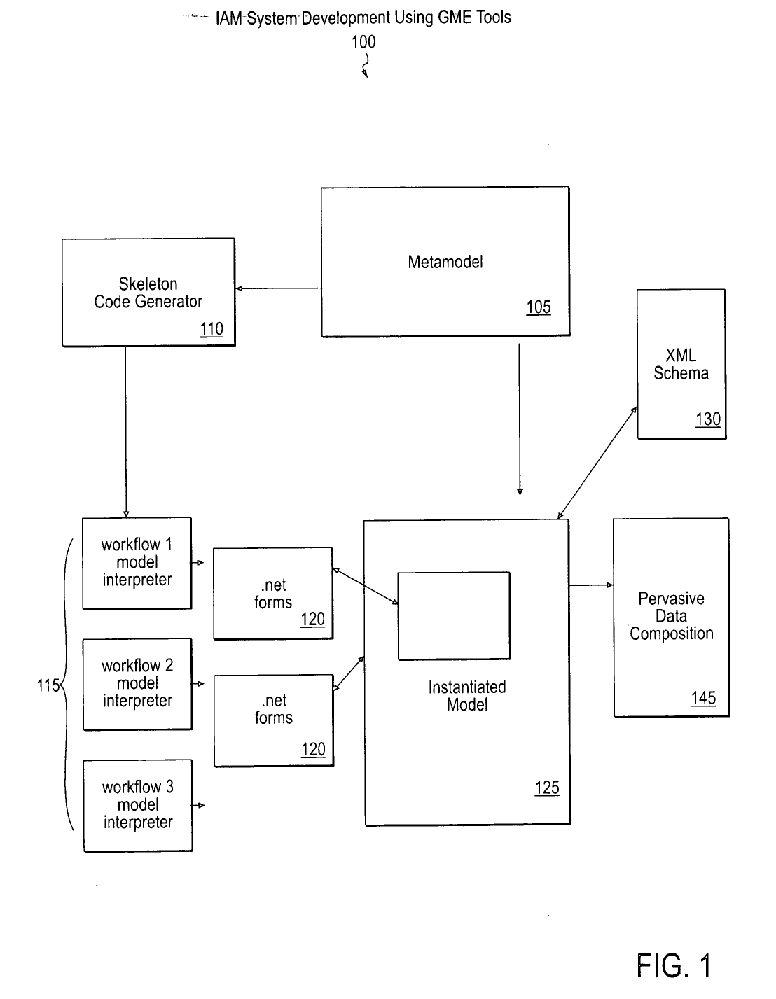

FIG. 1 is a schematic flowchart of the development of an IAM system, made in accordance with one embodiment of the present invention, using a GME toolkit. The IAM system is preferably constructed utilizing a toolkit referred to as a GME. Those skilled in the art will appreciate that other software toolkits could also be used to create a multi-level IAM system. This particular GME toolkit is available as free download software from the following website: http://www.isis.vanderbilt.edu/Projects/gme/download.html.

The GME software was developed at Vanderbilt University, Nashville, Tenn., as part of an Institute for Software Integrated Systems (ISIS) program. This GME software can be used to create a generic framework which is used to generate metamodels for an IAM system. This IAM system may be easily updated to add capabilities as desired when new features are needed or become commercially available.

The GME toolkit is a configurable toolkit that provides the ability to create domain specific modeling and then a programming environment behind that. A graphical modeling language is created made up of classes/objects associated with many different oil field asset components and connectors and a grammar defining the allowed and necessary connections between the asset components.

In a first graphical window, a developer of the IAM system can define domain specific models representative of assets and attributes, as shown in element 105. The metamodel 105 is a persistent generic classification of IAM system components. In one embodiment preferably, the GME is based upon a metamodeling language similar to the Unified Modeling Language (UML). In a meta-model all classes and subclasses and their connections are defined as components and subcomponents. For example, classes might include blocks, wells, piping networking systems and surface facilities systems. Each class contains sub-classes. For a well, the subclass may be a well performance curve, well design, and well perforations.

The Generate Skeleton Code from Metamodel process 110 creates a skeleton code, e.g., of C++ programming. Depending on the particular toolkit used for meta-modeling, skeleton code in other programming languages can also be created. The skeleton code assists in programming the required functionality for each of the classes. Instantiated model 125 is created based upon the meta-model components which are used as building blocks. In the instantiated model 125 a real asset framework is built as a persistent model for the asset. The instantiated models can provide multiple views known as aspects. These aspects can be arranged in a hierarchal arrangement for complex systems and can be used as placeholders for proxies.

Multiple work processes are implemented as Model Interpreters 115. The skeletal code from Generate Skeleton Code from Metamodel process 110 can be used to create the Model Interpreters 115 which are used, e.g., during automatic model synthesis. Forms built in the Visual Studio +.NET, available from Microsoft Corporation, in one embodiment are preferably used as a user interface. The forms may be used to augment GME interface tools linked to workflows or to specific IAM system components.

XML Schema 230 is defined to standardize the format for data exchange between various components of the IAM system. XML (eXtensible Markup Language) is widely used as a means of defining and standardizing the format of data exchanged between software components.

Pervasive Data Composition Middleware 145 allows extending the framework. A central component of the vision of an Integrated Asset Management (IAM) framework is an efficient and flexible mechanism for collection, aggregation, and delivery of information in the right format to the right consumer at the right time. A typical IAM system will incorporate a number of information consumers such as simulation tools, optimizers, databases, real-time control systems for in situ sensing and actuation, and also human engineers and analysts. The data sources in the system are equally diverse, ranging from real-time measurements from temperature, flow, pressure, and vibration sensors on physical assets such as oil pipelines to more abstract data such as simulation results, maintenance schedules of oilfield equipment, market prices, etc.

Different components such as simulators and optimizers in an IAM system should be able to exchange data in a correct and consistent format. A formal XML-based modeling of the input/output interface of each of these components 230, and a similar modeling of the interface to other data sources such as databases will enable such data exchange. However, this approach assumes that the burden of collecting and interpreting raw data from various sources is the responsibility of the consumer. If some data becomes temporarily unavailable due to, say, connectivity problems in the field, the consumer is expected to handle this situation by extrapolating from earlier cached data from the same source, etc.

Although this is feasible, it will lead to a duplication of effort in each of the consumers in a large-scale IAM framework. Also, an oilfield asset could possibly have a large number of data sources of different types. Continual rewriting of each consumer application to handle the increasing number of data sources (with the associated error handling and recovery logic) will become prohibitively expensive and error prone. A pervasive data composition middleware 245 acts as the data exchange intermediary between various data sources and the consumers. All the source-specific data refinement and error handling logic is implemented in this middleware 245, and the consumer application merely indicates, through a well-defined data model, the required quality-of-service (QoS) parameters for a particular type of data.

The GME workspace allows the metamodel 105 as well as the instantiated model 125 to be created in the same environment. In the metamodel, components are defined as well as, their relations, attributes, and visualizations and in the instantiated model this is used to define the assets model. Usually the metamodel portion has been developed with a team who are expert in the entire asset. After that, users will use this GME tool to create their instantiated model.

An instantiated model may be built by a user of the IAM system to provide a customized IAM system. Icons of asset components, such as reservoirs (blocks), well systems, piping systems, and processing units may be used. Each of the icons has layers of coding behind it to create different levels of analysis.

The GME tool in this exemplary embodiment is used to map an oil and gas field. The components of the oil field are divided to two main groups. Those components having more of a physical sense are called physical assets and the rest of the assets are referred to as non-physical attributes. Examples of physical components, by way of example and not limitation, may include: 1) reservoirs (or blocks comprising reservoirs); 2) wells; 3) pipe networks; 4) separators; and 5) process plants. Non-physical assets or attributes may include 1) control strategy; 2) assumptions on assets/attributes; 3) reliability; 4) availability; 5) real time data; event scheduling; 6) report and 7) documentation; and 8) risk.

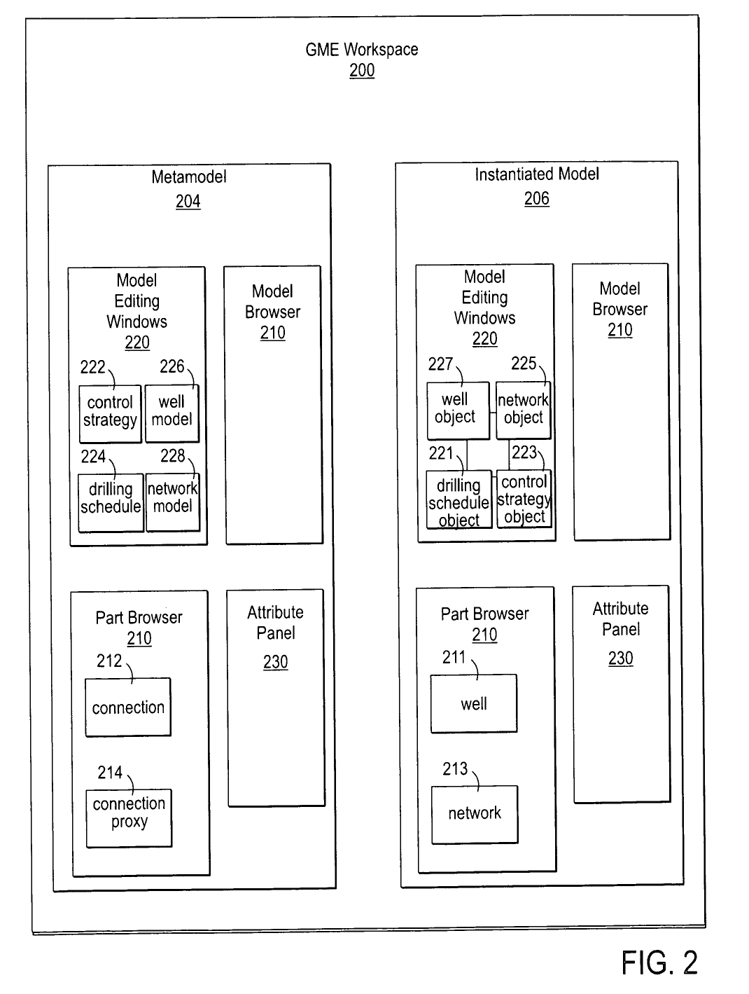

FIG. 2 is a schematic drawing in one preferred embodiment of the four main parts of a modeling environment workspace 200. These parts include a parts browser 240, an attribute panel 230, a model editing window 220, and a model browser 210. The part browser 240 in the metamodel 245 is categorized in four tabs as shown in Table 1 below. Various other modeling environments, known or later developed, may be used, having four or other numbers of sub-windows.

TABLE 1
PART BROWSER

| Class Diagram | | Visualization | Constraints | Attribute |
|---|---|---|---|---|
| Atom | Atom Proxy | Aspect | Constraint | Boolean |
| Connection | Connection | Aspect | Constraint | Attribute |
| Connector | proxy | Proxy | function | Enum |
| Equivalence | FCO Proxy | Same | | Attribute |
| FCO | Folder | Aspect | | Field |
| Implementation | Proxy | | | Attribute |
| Inheritance | Model | | | |
| Interface | Proxy | | | |
| Inheritance | Reference | | | |
| Folder | Proxy | | | |
| Model | Set Proxy | | | |
| Reference | | | | |
| SameFolder | | | | |
| Set | | | | |
| Inheritance | | | | |

A class diagram includes generic types of parts which are combined to create the metamodel. For instance, atoms are the elementary objects which can not contain parts. Models are the compound objects which can contain other parts like model or atom. The use of a connection and connector between two parts in the metamodel indicates that the corresponding instances of those parts in the instantiated model can be connected to each other. References are similar to pointers in a programming language. The use of a reference in association with a specific part in the metamodel allows the instantiated model to contain a “pointer” to an instance of that part. Sets can be used to specify a relationship among a group of objects. The creation of a set of one or more parts in the metamodel allows the creator of the corresponding instantiated model to define a set of instances of those parts in the instantiated model.

Almost all the parts have proxies. The purpose of proxies is to simply the creation and management of a complex metamodel. Proxies allow the metamodel to be split into multiple “sheets” where each sheet contains a portion of the complete metamodel. Multiple metamodel developers can define models, connection, aspects, folders, references, sets, etc., for their own portion of the metamodel. These portions can be combined into a larger metamodel by use of proxies.

Just as proxies are useful in handling complexity at the metamodeling level, references and containment are some of the ways of handling complexity at the instantiated model 250 level.

Visualizations are used to establish what icons or aspects are shown in a particular screen. Proxies again are used with aspects or icons. Aspects provide primary visibility control. In every aspect, a developer can choose those parts and components that he or she wishes to have visible for different levels.

Constraints are used to limit or control variables in the model. The constraints can be values or functions. Constraints represent the assertions that must be true in the instantiated model. One of the reasons for using constraints in the metamodel is to ensure that the creator of the instantiated model can only create “valid” models where the notion of “validity” is encoded in and enforced by constraints.

Attributes can be added to any component. Each part must have a name attribute. Multiple user-defined attributes can be associated with the parts in a metamodel. An attribute could be Boolean, enum, or field attribute. The metamodel developer can specify the name of the attribute, the type of the attribute, and can also provide default values for the attributes.

In the model editing windows 220, parts can be selected from the part browser 240 and then dragged and dropped in the model editing windows 220 to define the instantiated model or metamodel structure.

The attribute panel 230 in the metamodel 245 and instantiated model 250 are different. In this panel attributes, preferences, and properties are defined. During metamodel creation, the attribute panel shows attributes that are defined by the MetaGME language used to create the metamodel. During the creation of an instantiated model based on a particular metamodel, the attribute panel 230 for a part shows the attributes that are defined for that part by the developer of the metamodel.

To create a new instantiated model, a new model editing window needs to be opened. The model browser 210 in the instantiated model 250 lists all the components that have been created in the instantiated model. The model browser provides an alternate means of navigating the instantiated model. The number and type of components that can be instantiated in the model depend on the metamodel (“modeling paradigm”) being used to create the instantiated model. For instance, the metamodel might specify that one of the components in the domain is called “Block” and that component can contain multiple instances of another component called “Well”.

In the corresponding instantiated model, the user can drag in the component “Block” from the parts browser into the model editing window. Then the user double clicks on the newly instantiated “Block” component in the model editing window. The component “Well” is now available to the user in the parts browser. The user can now drag in multiple instances of the component “Well” from the parts browser into the model editing window. Each instance of the “Well” component will ideally map to a physical well that is part of the particular oilfield being modeled.

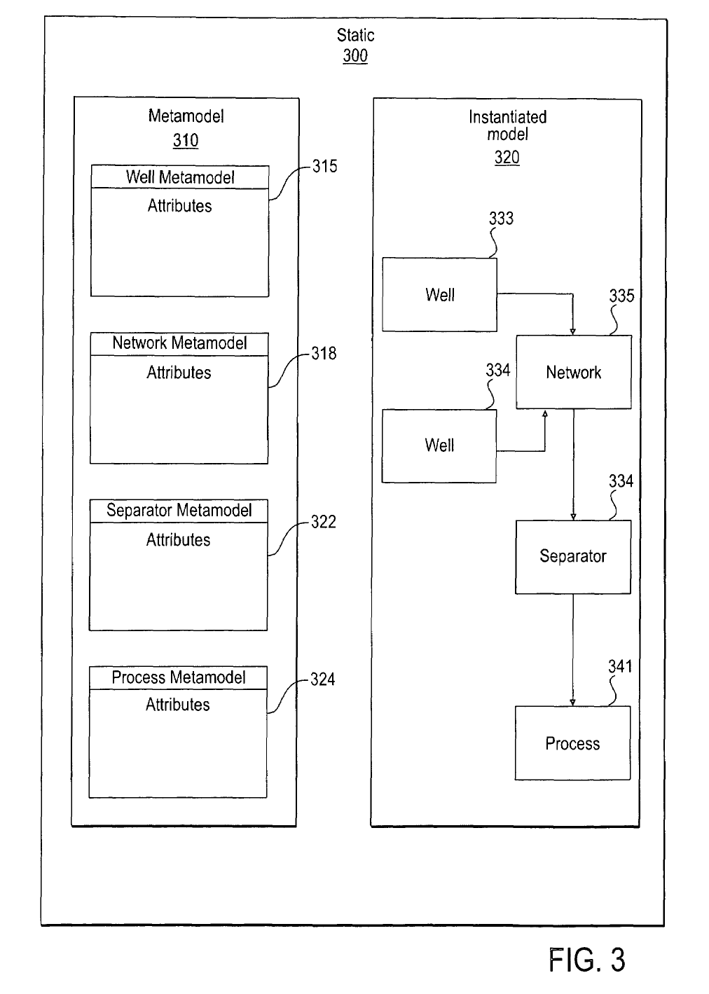

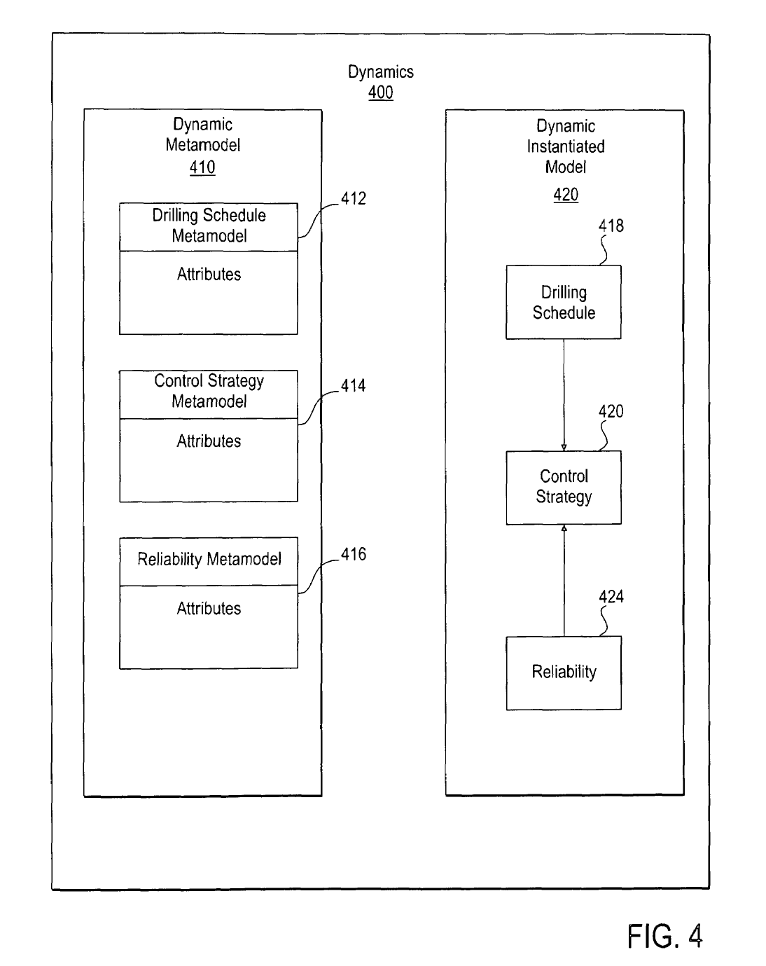

FIGS. 3 and 4 are schematic drawings in one embodiment of the invention of a metamodel and corresponding instantiated model for a static aspect and dynamic aspect. In FIG. 3, an aspect has been defined which is called “Static” 300. This aspect can provide visibility to “Well”, “Pipe network”, “Separator”, and “Process” and their connections. Metamodel 310 is used to create static instantiated model 320. The same concept has been applied for a “Dynamic” aspect 400 in FIG. 4. Metamodel 410 is used to create dynamic instantiated model 420. In this case, the non-physical attributes which may include, e.g., reliability, assumptions, real time data, and drilling schedule, all of which are connected to a control strategy. Exported from the control strategy is a report. Also, available in the instantiated model is an uncertainty model for one or more physical components, a risk model, economic model, and a decision support model.

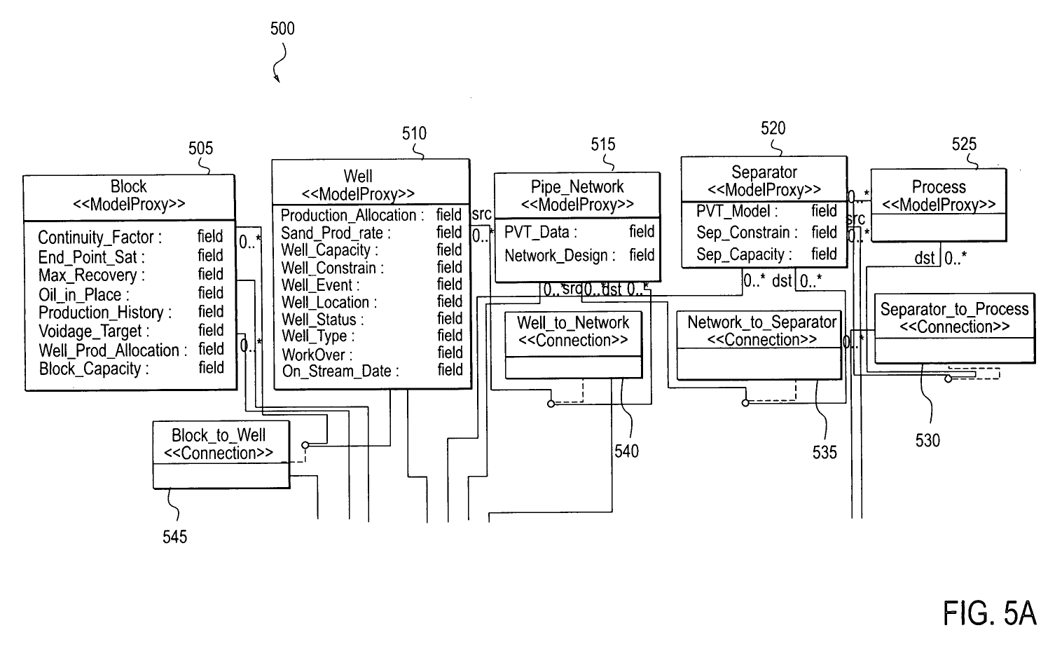

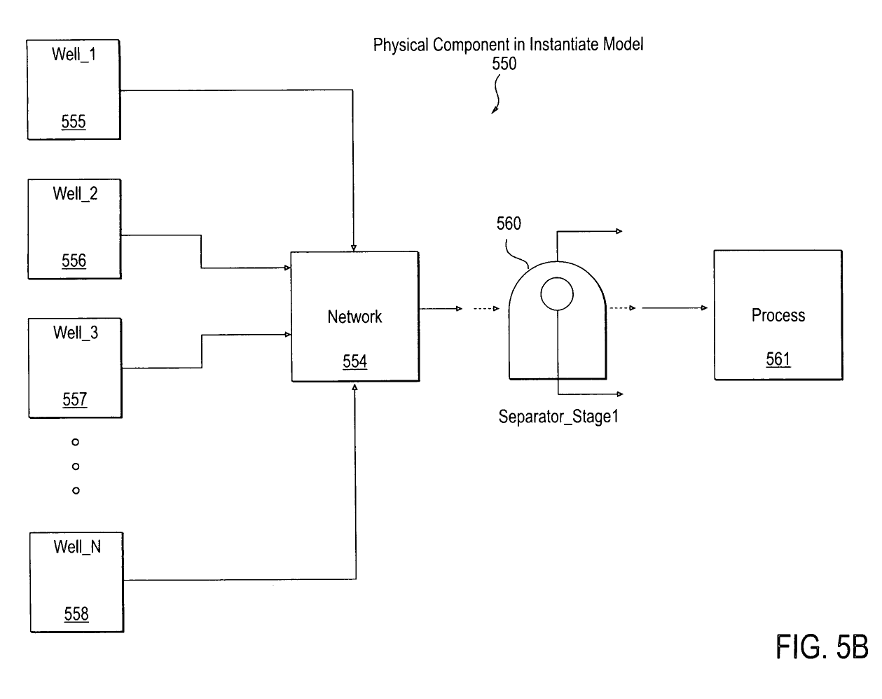

FIG. 5a is a schematic drawing 500 in one embodiment of the invention of physical components or assets in a metamodel. These components include a block 505, a well 510, a pipe network 515, a separator 520, and a process 525 for processing produced fluids. For each of these components, sub-components are specified which are used to interface with simulators. For the instance of a block component, subcomponents needed by a reservoir simulator include a) continuity factor; b) end point saturation; c) maximum recovery; d) oil in place; e) production history; f) voidage target; well production allocation; and block capacity. As can be seen from FIG. 5a, numerous of these sub-components are also used in the metamodel for the well, pipe network, separator and process components.

FIG. 5b is a schematic drawing in one embodiment of the invention of physical components or assets in an instantiated model 650 corresponding to FIG. 5a created by a user based upon the metamodel components of FIG. 2. A user has selected four wells 555, 556, 557, and 558 which are connected to a pipe network 559. The pipe network 559, in turn, is connected to a separator 560. Fluids from the separator 560 are then processed by a particular process 561.

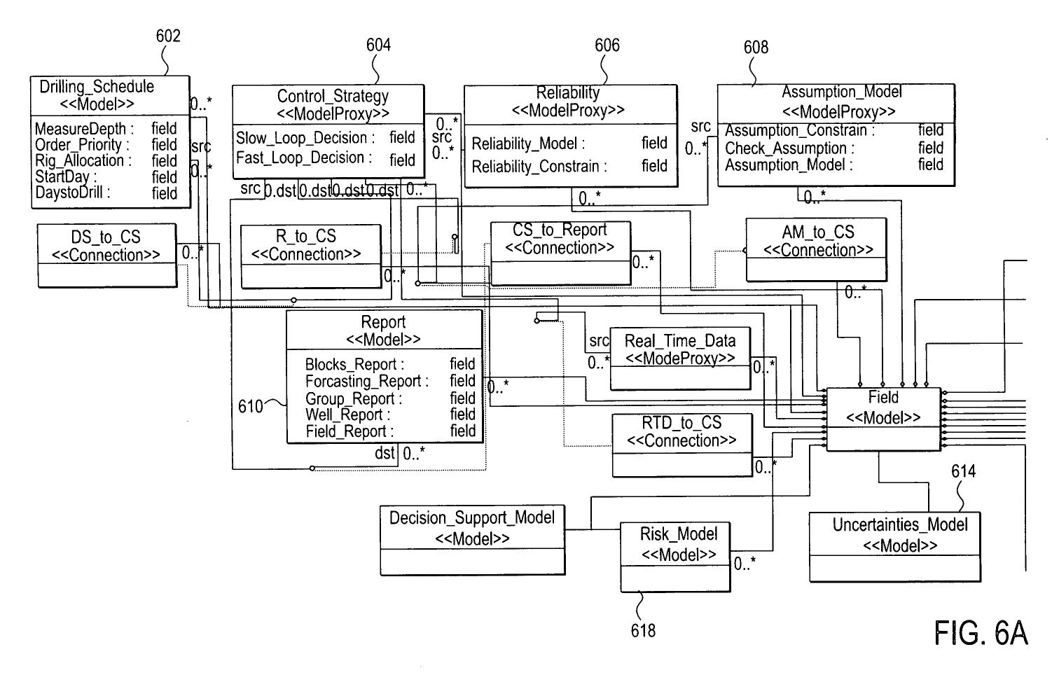

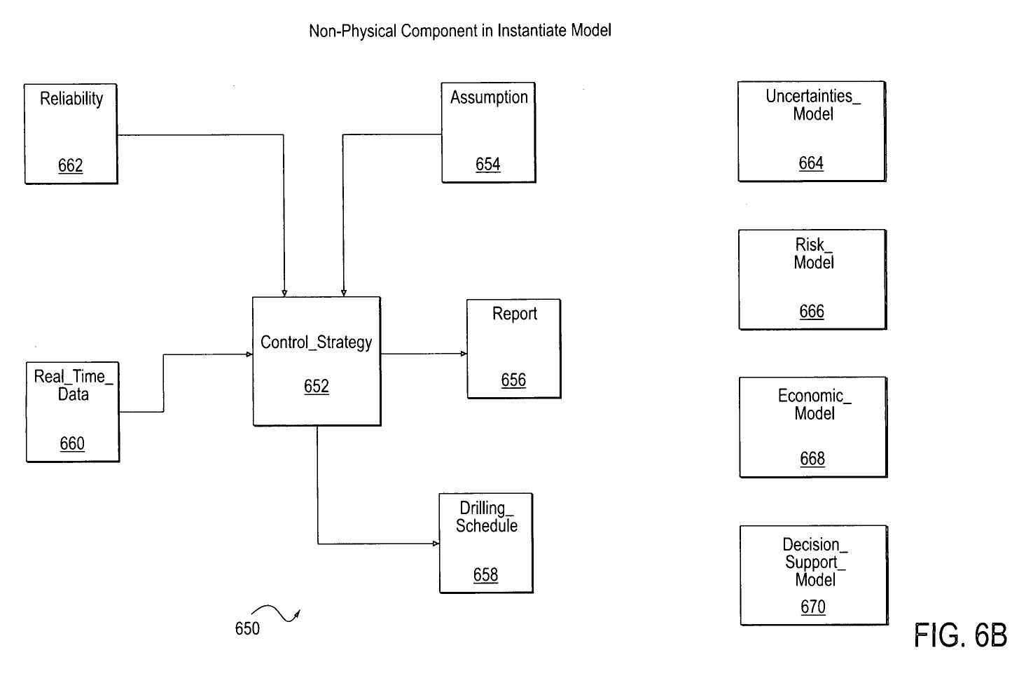

FIG. 6a is a schematic drawing in one embodiment of the invention of non-physical components 600 or attributes in a metamodel which are needed by a developer to model the IAM system. The components include a) drilling schedule 602; b) control strategy 604; c) reliability 606; d) assumption model 608; e) real time data 616; f) report model 610; g) field model 618; h) uncertainties model 614; and i) risk model 618. Once these components are coded by the developer, a user can pick and choose which of these components can be selected to create an instantiated model.

FIG. 6b is a schematic drawing in one embodiment of the invention of non-physical components 650 or attributes in an instantiated model corresponding to FIG. 6a. Inputs to a control strategy 652 are shown as a reliability model 662, an assumption model 654, real time data 660 and a drilling schedule 658. Output from the control strategy is a report 656. Other models which may be integrated into the IAM system include uncertainties model 664, risk model 666, economic models 668, and decision support models 670.

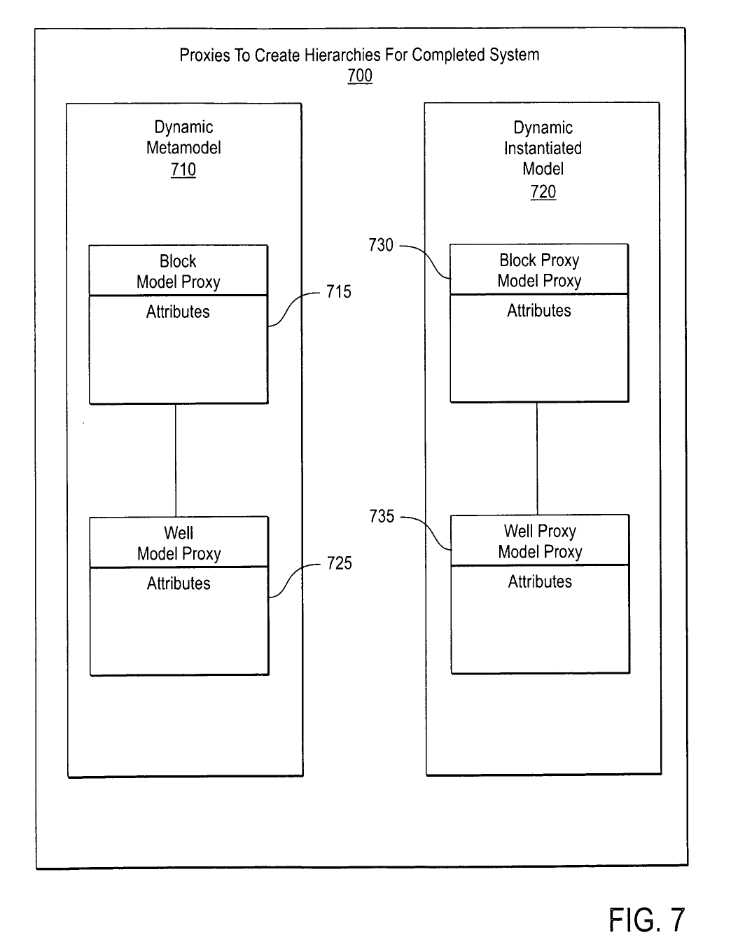

FIG. 7 is a schematic drawing in one embodiment of the invention illustrating how proxies are used to complexity in a metamodel. In this example, a block metamodel has been defined in its own sheet. At the same time, a block model proxy 715 has been used in the main paradigm which includes all sub-paradigms for physical and non physical components. The block model proxy is linked to the block metamodel. When the user double clicks on the Block model proxy part 815 in the main paradigm, the metamodeling environment opens the block paradigm 725.

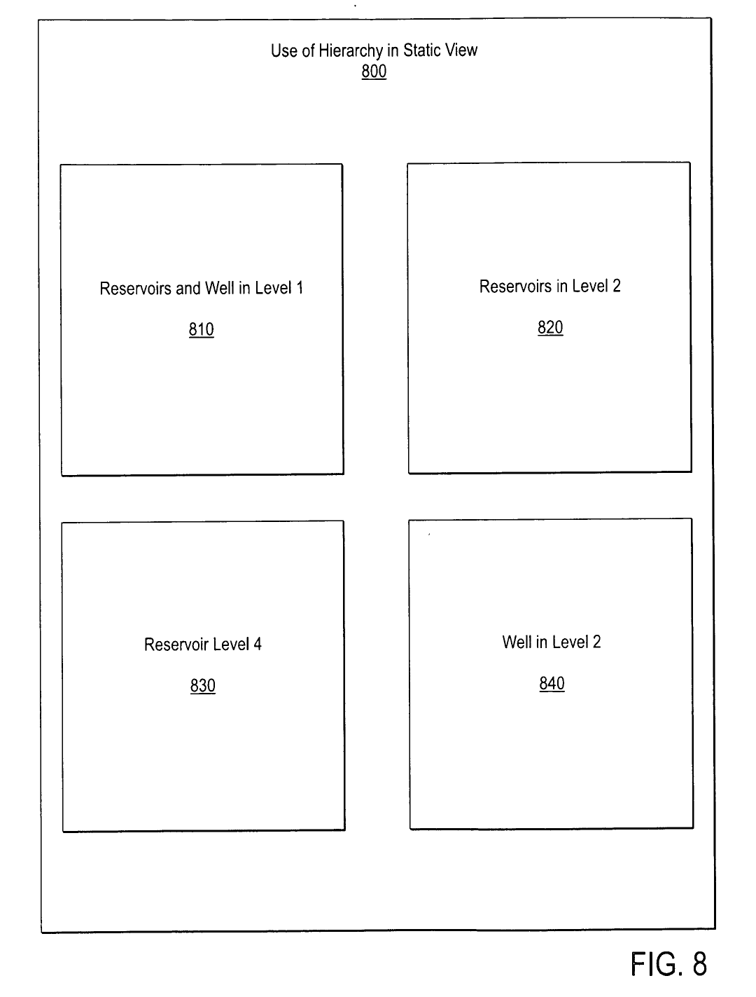

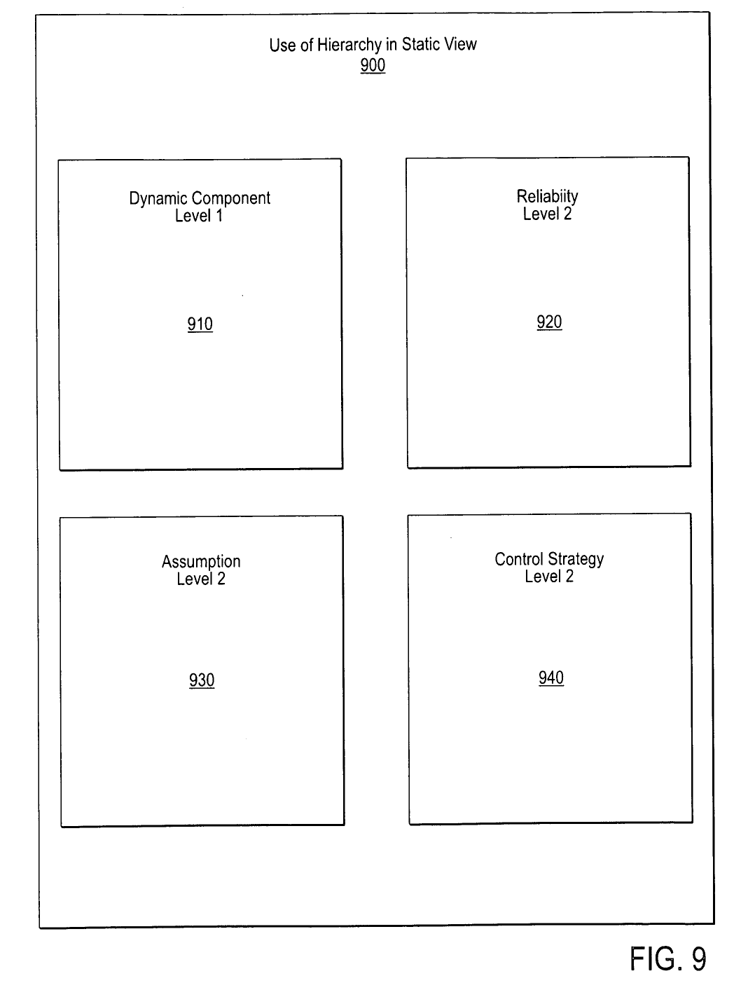

FIGS. 8 and 9 show different levels of some assets. FIG. 8 is a schematic drawing in one embodiment of the invention of the use of hierarchies in a static view. FIG. 8 shows the first level 810 in reservoir design. The arrangement of how reservoirs are connected to wells is shown. At the level two 820 of the block, assumption, fluid properties, and recovery process are associated with blocks. Level two 840 of the well shows a combination of assumption, reliability, real time data sets, well controller and well design. The last window illustrates level four 830 of reservoir simulation which is the most detailed level. This would correspond to factors needed to run a full scale reservoir simulator, such as Eclipse™.

FIG. 9 is a schematic drawing in one embodiment of the invention of the use of hierarchies in a dynamic view, i.e., the same concept as in FIG. 8 but for nonphysical components. More particularly, FIG. 9 shows level one of a dynamic aspect and level two of a reliability model 920, an assumption model 930, and a control strategy 940.

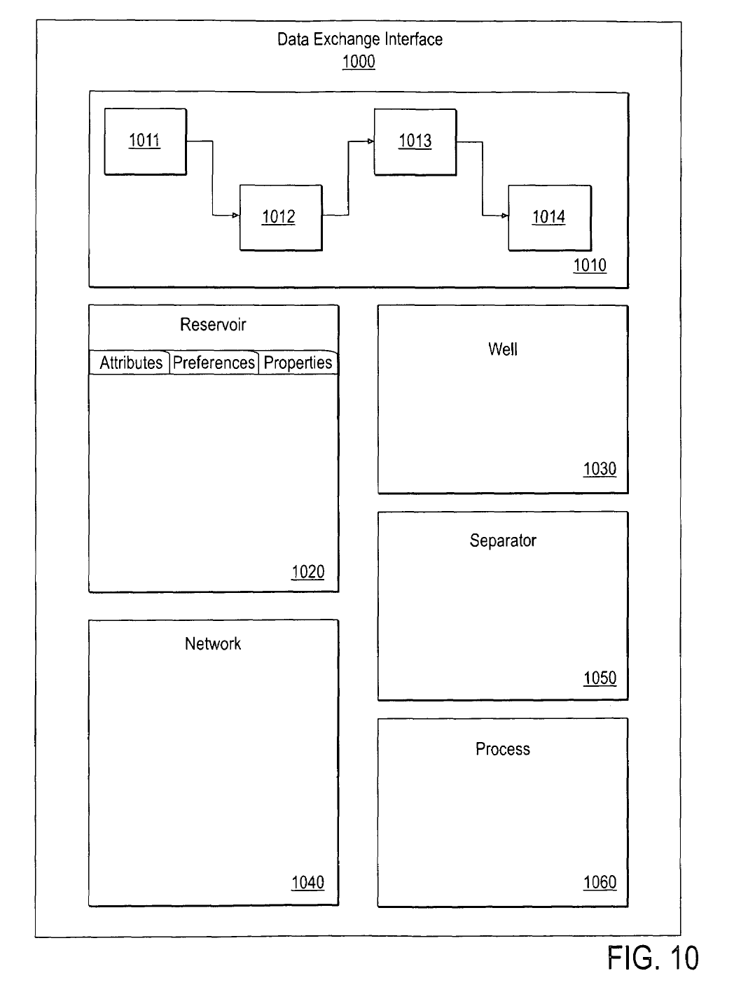

FIG. 10 is a schematic drawing in one embodiment of the invention of a Data Exchange Interface 1000 in an instantiated model and the corresponding metamodel components, reservoir 1020, well 1040, network 1040, separator 1050, and process 1060, in the lower portion of the drawing.

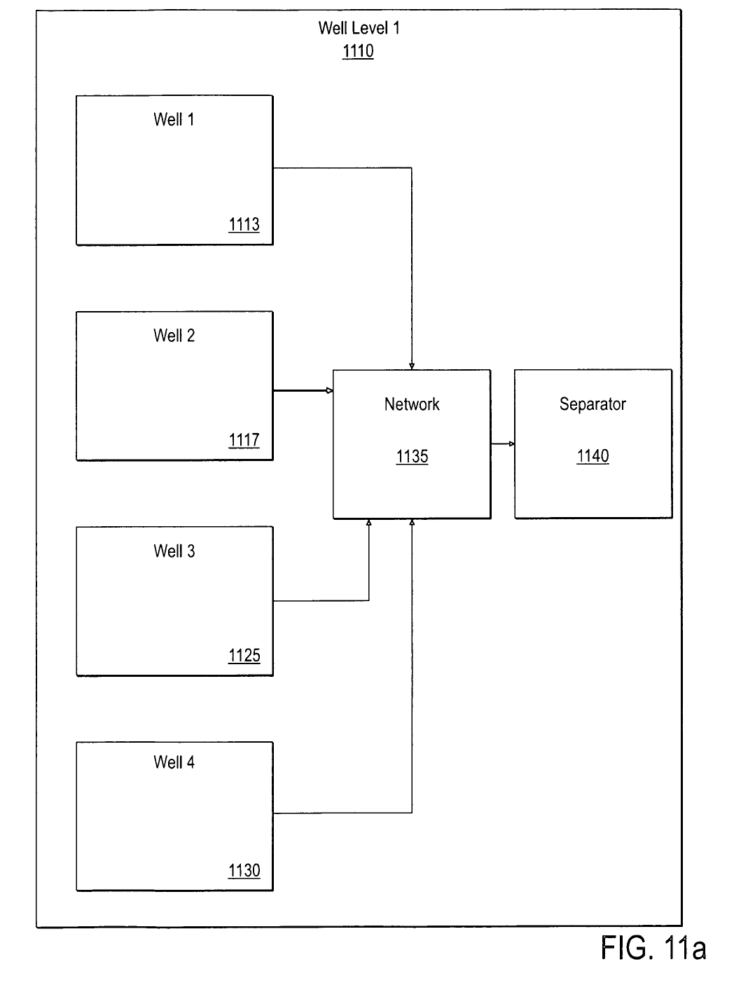

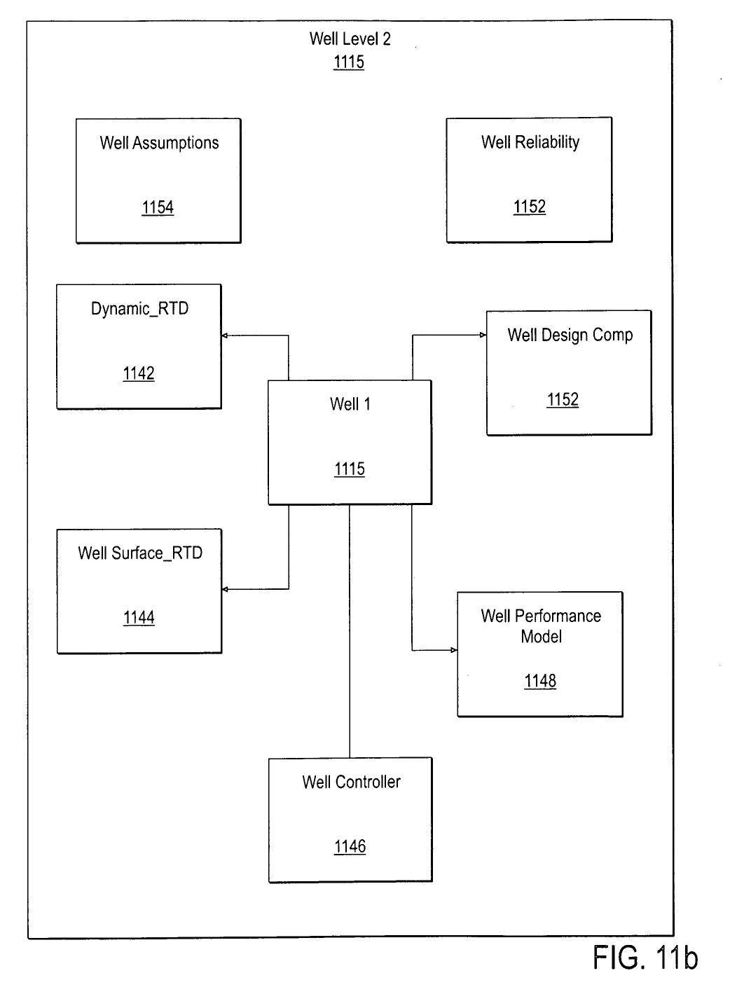

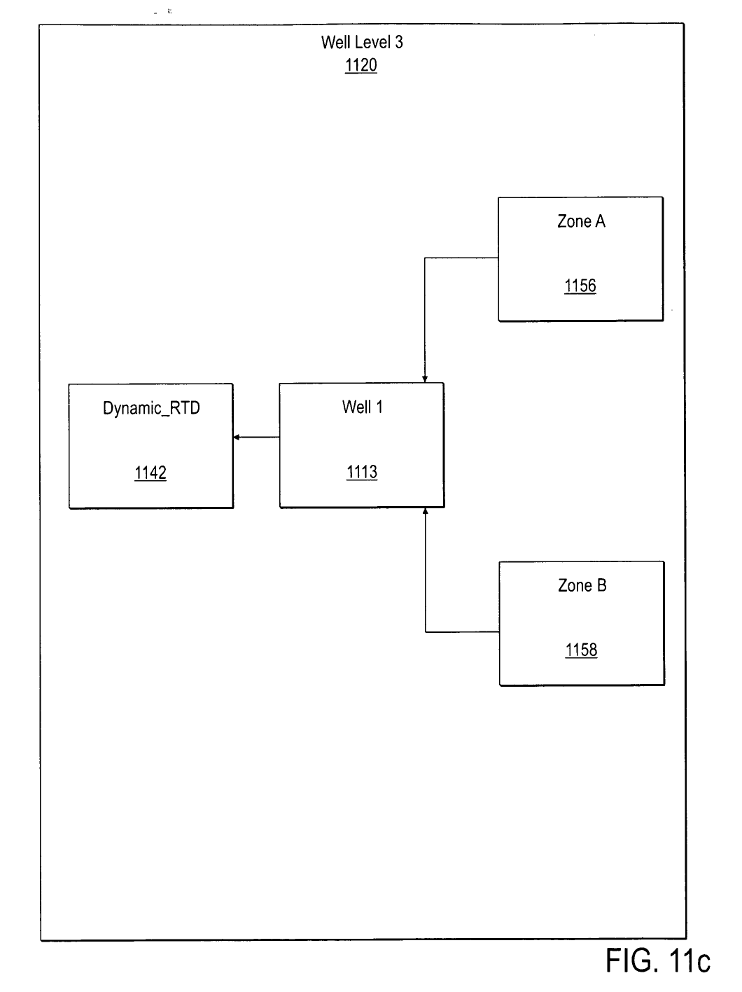

FIGS. 11a, b, and c are a schematic drawing in one embodiment of the invention of a well in levels 1, 2, and 3 of complexity or detail, respectively. In level one 1110 in FIG. 11a, four wells, 1113, 1117, 1125, and 1130, are shown which connect to a piping network 1135 which connects to separator 1140. At level two 1115 in FIG. 11b, an individual well 1115 is shown which has various associated components including well assumptions 1154, well reliability 1152, dynamic RTD (real time data) 1142, well surface RTD 1144, well design completion 1150, and well performance modeling 1148. A well control 1146 is also shown as part of the level two modeling effort. Finally, in level three 1120 in FIG. 11c, a well 1113 is shown connecting zones A 1156 and B 1158 and dynamic RTD 1142. Dynamic RTD 1142 indicates a set of data acquired by sensors in the well bore and these sensors will provide data at a high frequency. Well surface RTD 1144 is another set of data that is also to be acquired in ‘real time’ and relates primarily to the observed properties at the well head.

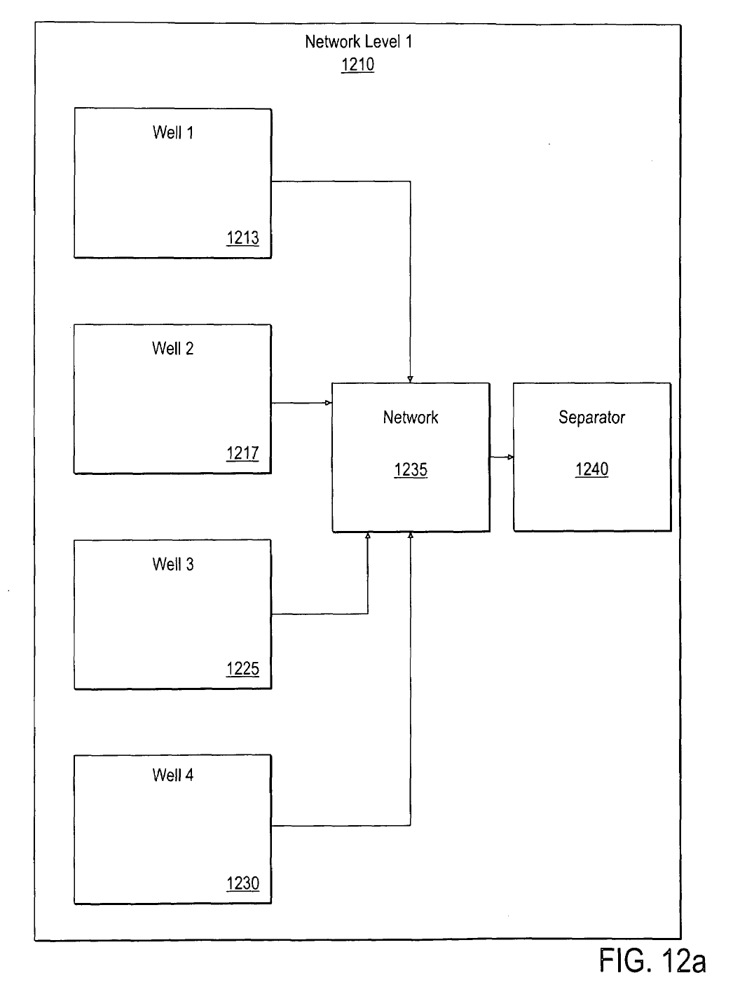

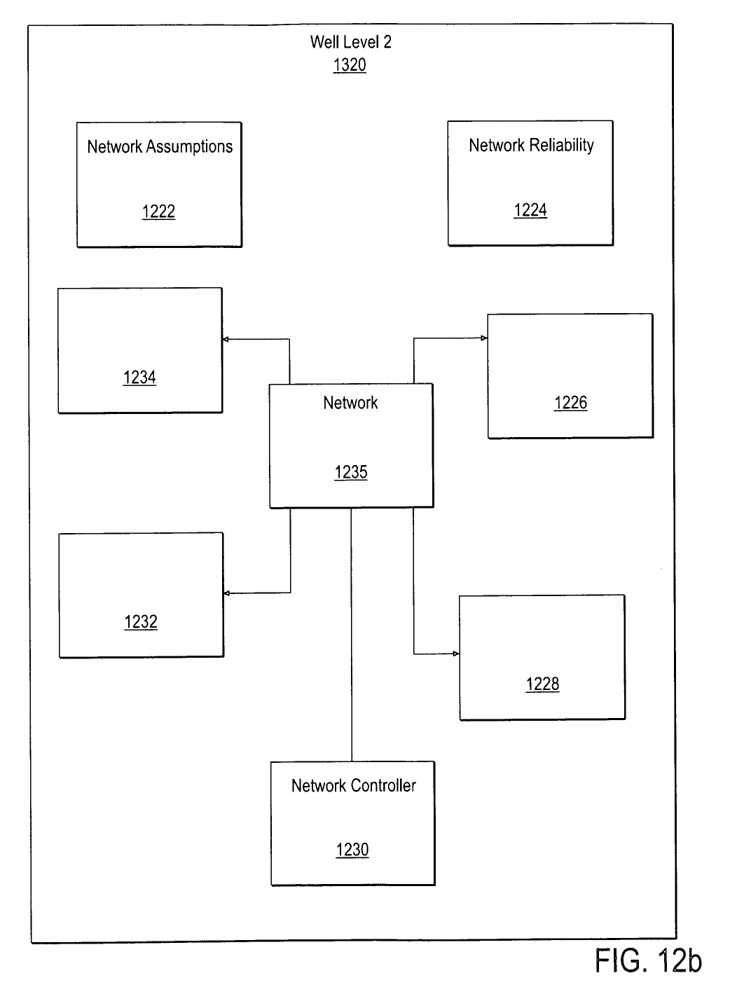

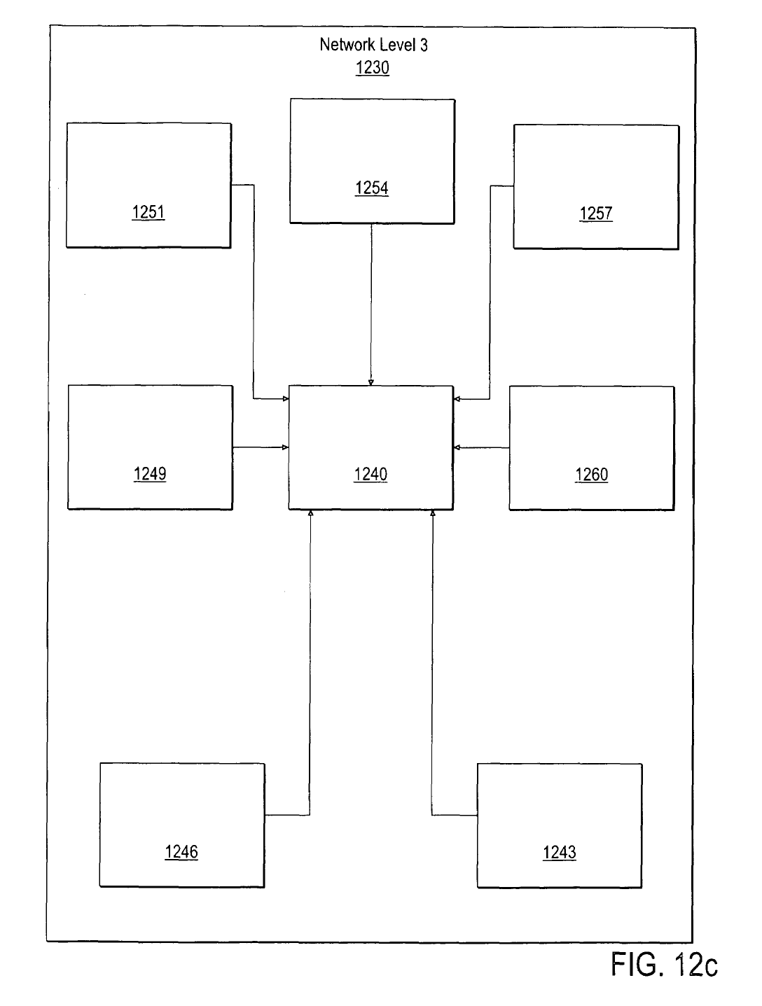

FIG. 12a, b, and c are a schematic drawing in one embodiment of the invention of a network in levels 1, 2, and 3 of complexity or detail, respectively. In level one 1210 in FIG. 12a, or the highest level, the network 1235 is shown connected to four wells and a separator. FIG. 12a replicates FIG. 11a discussed above.

At lower level two 1220 in FIG. 12b, the network 1235 is specified by network assumptions 1222, network reliability 1224, network design 1236, network composition 1228, network RTD 1232 and Network output RTD 1234. For analyses at an even greater level, additional information is required. In this case, in level three 1230 in FIG. 12c, several network simulation factors are specified including, composition track 1254, prediction method 1257, system output constraint 1260, VL production design 1243, prediction system constraints 1246, optimization method 1249 and prediction information 1251.

### C. Conceptual Levels of Integrated Asset Management System

In considering proposed solutions, it will be useful to categorize Integrated Asset Management toolkits in terms of the levels of detailed modeling and the potential use case work processes that benefit from Integrated Asset Modeling tools. Table 2 below captures summary descriptions of this categorization.

| | | | Abstraction or | |
|---|---|---|---|---|
| | | | representation of | Visualization and |
| | | | major | Presentation of |
| Level | Usability | Integration | components | Information |
| 1 | High level scans | Shared set of | Major system | Fully system reports |
| | integrated | assumptions | components | and graphs |
| | process analysis | among all | represented by | |
| | | components | single values, | Interactions and |
| | Immediate | | table look-up or | influence among |
| | | Validation against | response surfaces | components |
| | Appropriate for | assumption | | |
| | fast closed loop | manager | E.g.: Full system | Comprehensive |
| | | | reliability may be | set of system |
| | Full system | May not include | one number per | assumptions to |
| | representation | all systems | major period | insure |
| | | components (well, | | consistency |
| | Broad | network, process | Simple | across integrated |
| | uncertainty | reservoir model | engineering | team |
| | spectrum, | may be | models: Material | |
| | 1000s' of cases | necessary) | Balance, type | |
| | | | curves | |
| 2 | Links to DA and | Synchronization | | |
| | economics | of simple | Simple fluid | |
| | | engineering | characteristics | |
| | Integrated short | models from more | (FVF & GOR) | |
| | term forecasting | detailed models | representative of | |
| | | (insure MBAL | reservoir regions | |
| | Monthly | pressure decline | | |
| | production | tracks detailed | Breakdown of | |
| | review | simulation) | system into | |
| | | | multiple | |
| | Major | Publication of | components | |
| | component | model | (production train, | |
| | reliability and | assumptions for | injection, | |
| | impact on | sharing among | compression | |
| | forecasting | components | systems | |
| | Impact of drilling | | | |
| | programs | | | |
| | Short term or | | | |
| | instantaneous | | | |
| | optimization | | | |
| | Calibration | | | |
| | against real time | | | |
| | using simple | | | |
| | multiplier | | | |
| | corrections | | | |
| | Could be linked | | | |
| | to financial or | | | |
| | cost models | | | |
| 3 | Optimization and | Explicit data | Detailed process | Full System reports |
| | debottlenecking | exchanged of | or network | and graphs |
| | | component model | | |
| | Detailed design | results | Fully functional | Flag of critical |
| | with possible | | reservoir simulator | constraints |
| | focus into | Gaps in full range | but in reduced | |
| | specific | of system | form for efficient | Report of automatic |
| | components | components filled | run times | and manual data |
| | (facility, network, | in with proxies | | exchange |
| | or new | | Rigorous Lumping/ | |
| | development | Inclusion of full | Delumping of fluid | Track critical |
| | wells) | range of potential | data for | variables (P and T) |
| | | constraints on | consistency of | across integrated |
| | Appropriate for | system including | fluid | system |
| | major new | soft rules | characteristics | |
| | capital or well | | across system | Track critical variable |
| | expenditures, | Explicit data | | (P and T) across |
| | business plan | interchange | Detailed base | integrated system |
| | | | case models | |
| | Good | Tight coupling | | Visualization of |
| | representation | | Few assumptions | specific components |
| | for developing | “Accurate domain | | belongs to domain |
| | detailed OPEX | models | | expert |
| | and making links | | | |
| | to cost models | | | |
| | for interventions, | | | |
| | mean time to | | | |
| | failure wells, etc. | | | |
| | Able to select | | | |
| | from multiple | | | |
| | models, cases | | | |
| | and scenarios | | | |
| | Would require | | | |
| | new technology | | | |
| | to maintain | | | |
| | consistent | | | |
| | calibration of | | | |
| | models in real | | | |
| | time | | | |
| | Calibration of | | | |
| | coarse level | | | |
| | models | | | |
| 4 | Detailed design | | | |
| | Few predictions | | | |
| | of 1 or two cases | | | |
| | may require long | | | |
| | computation run | | | |
| | times | | | |
| | Focused | | | |
| | detailed | | | |
| | prediction for | | | |
| | critical transition | | | |
| | periods in life of | | | |
| | asset (onset of | | | |
| | decline) | | | |

### D. Multiple Choices of Programs for a Particular Asset Component—Use of Model Interpreters

Another aspect of the present invention is that any one of a number of software programs can be selected to be used as a particular asset component. For example, at level 4, a highly detailed reservoir simulator is to be employed in the preferred embodiment. By way of example, and not limitation, examples of preferred commercially available reservoir simulators might include Schlumberger's Eclipse™ reservoir simulator, Halliburton's VIP™ reservoir simulator, or CMG reservoir simulator. This allows a domain expert, i.e., a reservoir simulation engineer, to use the preferred reservoir simulator of the user's choice. One user may be more familiar with ECLIPSE while another may prefer to run CMG reservoir simulator.

All of these application programs are in communication with a model interpreter. Each model interpreter is designed to acknowledge the necessary input and output variables of a particular application and to convert these variables into a common data exchange protocol, preferably, Extensible Markup Language (XML). Similarly, this XML preferably can then be converted to the necessary input and output variables needed to communicate with a variety of other programs such as piping network programs. Examples of such piping networks include Schiumberger's PIPESIM™, Petroleum Experts GAP™, or Simulation Sciences PIPEPHASE™ Consequently, any commercial or proprietary software package can be made to work with any commercial or proprietary software package within the IAM system.

A user of this IAM system can therefore readily designate not only the desired level of analysis for each of the component assets when conducting an IAM system simulation but also select the desired software program for a particular asset component. Of course, the model interpreters will have to have been previously coded to work with any of the software programs which are to be provided within the IAM system.

### E. Assumption Manager and Proxy Generator

The present invention in one embodiment preferably includes an assumption manager. The assumption manager lets planners indicate which parameters are of concern between the models, and which conditions they want to explore in setting up the composite simulation. A proxy generator generates missing information and creates multiple alternative scenarios. This component could comprise of multiple tools based on simple analytical methods, rules extracted from analogs or industry databases, or manual entry to create all the data required to run the high level simulator in a stand-alone mode as a simulation game, i.e., the class of “simulation games” that allow the user to create various scenarios and observe the outcomes.

A data review and monitoring aid that integrates real-time sensors, logs, corporate data systems and simulation predictions to look for conditions that violate the assumptions underlying the resulting plans, alerting corporate planners and decision makers if needed.

A decision support aid that provides an interface to the preceding tools allowing planners and decision makers to evaluate in parallel consequences and potential costs of different assumptions and proposed priorities, and to record the decisions, plans and accompanying assumptions which were ultimately adopted.

### F. Use of Response or Transfer Functions Between Asset Components

Communication between different component assets, such as between reservoir simulator and a piping system may in certain cases be accomplished using a response or transfer function. Boundary conditions between these component assets, or physical models, may not be otherwise correct because of gaps in boundary conditions or a requirement that some additional computation or aggregation of multiple levels of detail is required.

An example is where a flow regime includes slug flow. A flow regime is described in a pipe network as characteristic of the flow behavior but flow computations and correlations based on this characteristic do not describe details of the minute fluctuations in a well's effluent stream that could prove significant for understanding behavior in the process separator inlet. Slug flow occurs as a consequence of simultaneous flow of both oil and gas in a producing oil well. The present IAM system in one embodiment preferably overcomes this shortcoming by using response or transfer functions.

### G. Ensuring a Higher Level of Consistency Between Analysis on Asset Components

In one embodiment, the IAM system preferably is run to ensure the consistency between levels. For example, at level one the processing system may have an overall efficiency of 97%. At a lower level, such a level four, the processing system may include a production train or separator system, a water injection system and a gas injection system. Separator systems generally have very high reliability such as on the order of 99% reliability. Pumps used in water injection systems are also very reliable, on the order of 95%. However, compressors used in gas injection systems are potentially much less reliable, i.e., on the order of 85%. However, there may be a discrepancy in the estimates of reliability between levels.

For example, level one overall reliability may be 97%. That is, the field system is estimated to produce 97% of the time based on an analysis that incorporates one set of assumptions regarding the production-injection scenario. If the analysis were to be done at a deeper level of integrated system description, say on level four, the reliability estimate may be calculated as follows:

[0.99(Qₛₑₚₐᵣₐₜₒᵣ)+0.95(Q_{-water pump})+0.85(Q_{compressor})]/3≠97%.

The IAM system of present invention in one embodiment preferably overcomes this shortcoming by checking reliability of components at a deeper level of detail and isolating the impact on flow conditions. Even more valuable is that this allows identifying specific mitigation strategies to improve overall efficiencies. An example situation is that of one of four water injection pumps being shut down for repairs. Under this specific condition there may be an opportunity to divert and accelerate water to other injection sites temporarily, then overloading water injection to the shut in area to catch up thus eliminating any detrimental impact to full system efficiency.

### H. Defining Multiple Patterns of Interaction

The IAM system will enable creating work processes for decision support that require differing patterns of interaction among the asset and non-physical components. This can be accomplished because of the consistent representation and access to multiple levels of detail simultaneously so that system interpreters can access simulators and proxies, aggregate and deliver information to a point of adjacency. Similarly, system interpreters can process combined models that need to interact at deeper levels of detail (i.e. level 4) and aggregate information assumed at the coarser levels (level 1).

### I. Decomposition of Problem Solving

A particular advantage of the present IAM system, using multiple-levels of analysis for at some of the component assets, is that problems found in the operation of the IAM system may be isolated and solved by domain experts. Once the problem is identified, then an appropriate domain expert can be assigned to solve the problem. For example, a domain expert for reservoir simulation, i.e., a reservoir engineer, can solve a problem found in the reservoir domain.

### J. Decomposition of System Development

IAM system development as enabled by GME allows for decomposition of the development processes. A single domain expert can develop the persistent IAM metamodel that provides a classification of the assets and non-physical components in the oil production operational domain. Local on-site field engineers can develop a specific integrated asset model framework for their producing field or development. Workflow processes can be developed independently by multiple technology experts and interfaced to the IAM system via model interpreters. Information received and published can also be developed independently and interfaced through model interpreters. Also, the present invention provides for an aggregation of an assembly of asset models in a plurality-to-one relationship, or aggregation of models at differing levels of detail before aggregating and scaling to coarser levels.

The present invention also includes a computer readable media which includes instructions for carrying out the method for creating an integrated asset management system for an oilfield. The method comprises creating a plurality of models of assets of the oil field, at least two of the models having a plurality of levels of complexities. The models having a plurality of levels of complexities are then connected to communicate with one another to create an IAM system. The level of complexities for the plurality of models is selected. Finally, an analysis is performed on the IAM system utilizing the selected levels of complexities to predict a characteristic of the IAM system.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention.

### K. Other Implementations

Other embodiments of the present invention and its individual components will become readily apparent to those skilled in the art from the foregoing detailed description. As will be realized, the invention is capable of other and different embodiments, and its several details are capable of modifications in various obvious respects, all without departing from the spirit and the scope of the present invention. Accordingly, the drawings and detailed description are to be regarded as illustrative in nature and not as restrictive. It is therefore not intended that the invention be limited except as indicated by the appended claims.

What is claimed is:

1. A method for creating an integrated asset management system for an oilfield, the method comprising:
(a) creating a plurality of models representing asset components each model having a plurality of levels of detail;
(b) connecting the plurality of models to communicate with one another to create an integrated asset management system;
(c) selecting the levels of detail for the plurality of models; and
(d) performing an analysis on the integrated asset management system utilizing the selected levels of detail to predict a characteristic of the integrated asset management system.

2. The method of claim 1, wherein the asset components comprise physical and non-physical assets.

3. The method of claim 2, wherein the physical asset components comprise pumps, subterranean reservoirs, pipe network systems, well bores connecting the reservoirs to pipe network systems, separators, processing systems for processing fluids produced from the subterranean reservoirs and heat and water injection systems.

4. The method of claim 2, wherein the non-physical asset components comprise reliability estimators, financial calculators, optimizers, uncertainty estimators, control systems, historical production data, and simulation results.

5. The method of claim 2, wherein the physical asset components are selected from the group comprising pumps, subterranean reservoirs, pipe network systems, well bores connecting the reservoirs to pipe network systems, separators, processing systems for processing fluids produced from the subterranean reservoirs and heat and water injection systems, and mixtures thereof.

6. The method of claim 2, wherein the non-physical asset components are selected from the group comprising reliability estimators, financial calculators, optimizers, uncertainty estimators, control systems, historical production data, simulation results, and mixtures thereof.

7. The method of claim 1 wherein a generic modeling environment is utilized to create the plurality of models each having a plurality of details.

8. The method of claim 1, further comprising utilizing a proxy generator to create a proxy for a model.

9. The method of claim 1, further comprising utilizing an assumption manager to maintain assumptions consistently between the models.

10. An integrated asset management system for an oilfield comprising:
(a) a plurality of models representing asset components of an oil field, at least two of the plurality of models having a plurality of levels of details;
(b) connections to allow communication between the models having the plurality of levels of details;
(c) wherein the level of complexities of models may be selected such that the level of analysis on the integrated asset management system can be performed at a selected level of detail to predict a characteristic of the integrated asset management system.

11. The method of claim 8, wherein the asset components comprise physical and non-physical components.

12. The method of claim 9, wherein the physical assets comprise pumps, subterranean reservoirs, pipe network systems, well bores connecting the reservoirs to pipe network systems, separators, processing systems for processing fluids produced from the subterranean reservoirs and heat and water injection systems.

13. The method of claim 9, wherein the non-physical asset components comprise reliability estimators, financial calculators, optimizers, uncertainty estimators, control systems, historical production data, and simulation results.

14. The method of claim 8 wherein a generic modeling environment is utilized to create the plurality of models each having a plurality of details.

15. The method of claim 8, further comprising utilizing a proxy generator to create a proxy for a model.

16. The method of claim 8, further comprising utilizing an assumption manager to maintain assumptions consistently between the models.

17. A machine-readable program storage medium tangibly embodying sequences of instructions, the sequences of instructions for execution by at least one processing system, the sequences of instructions to perform steps for:
(a) creating a plurality of models representing asset components of an oil field each having a plurality of levels of details;
(b) connecting the plurality of models to communicate with one another to create an integrated asset management system;
(c) selecting the levels of complexities for the plurality of models; and
(d) performing an analysis on the integrated asset management system utilizing the selected levels of details to predict a characteristic of the integrated asset management system.

18. The method of claim 17, wherein the asset components comprise physical and non-physical assets.

19. The method of claim 18, wherein the physical asset components comprise pumps, subterranean reservoirs, pipe network systems, well bores connecting the reservoirs to pipe network systems, separators, processing systems for processing fluids produced from the subterranean reservoirs and heat and water injection systems.

20. The method of claim 18, wherein the non-physical asset components comprise reliability estimators, financial calculators, optimizers, uncertainty estimators, control systems, historical production data, and simulation results.

21. The method of claim 17 wherein a generic modeling environment is utilized to create the plurality of models each having a plurality of details.

22. The method of claim 17, further comprising utilizing a proxy generator to create a proxy for a model.

23. The method of claim 17, further comprising utilizing an assumption manager to maintain assumptions consistently between the models.

24. A system for developing an integrated asset management framework for an oilfield comprising:
(a) a metamodel have classes and subclasses representing asset components and component connectors at multiple levels of detail for modeling a plurality of oilfield-domain specific software applications and their associated input and output data signals, wherein the metamodel is adapted and configured for generating instantiated models at multiple levels of detail of a plurality of different oilfields by user selection of components and component connectors for each given oilfield;
(b) a graphical user interface configured and adapted for user selection of components and component connectors for instantiated a model for each given oilfield;
(c) a least one model interpreter configured and adapted for communication between different instantiated models;
(d) an XML schema configured and adapted for storing input and output signals of the a plurality of oilfield-domain specific software applications; and
(e) an assumption manager configured and adapted for maintaining assumptions consistently between the instantiated models and multiple levels of instantiated models.

25. The method of claim 24, wherein the asset components comprise physical and non-physical assets.

26. The method of claim 25, wherein the physical asset components comprise pumps, subterranean reservoirs, pipe network systems, well bores connecting the reservoirs to pipe network systems, separators, processing systems for processing fluids produced from the subterranean reservoirs and heat and water injection systems.

27. The method of claim 25, wherein the non-physical asset components comprise reliability estimators, financial calculators, optimizers, uncertainty estimators, control systems, historical production data, and simulation results.

28. The method of claim 24, further comprising a proxy generator configured and adapted to create a proxy for an instantiated model.
